(19) United States
(12) Patent Application Publication
(10) Pub. No.: US 2024/0188755 A1
(43) Pub. Date: Jun. 13, 2024

(54) COFFEE PERCOLATOR AND METHOD OF DELIVERING COFFEE

(71) Applicant: LA SAN MARCO S.P.A., Gradisca d'lsonzo (IT)

(72) Inventors: Roberto NOCERA, Gradisca d'Isonzo (IT); Stefano BOLZAN, Gradisca d'Isonzo (IT)

(21) Appl. No.: 18/286,591

(22) PCT Filed: Apr. 7, 2022
(86) PCT No.: PCT/IT2022/050089

§ 371 Date: Oct. 12, 2023

(30) Foreign Application Priority Data
Apr. 16, 2021 (IT) 102021000009692

(51) Int. Cl. A47J 31/52; A47J 31/00; A47J 31/36; A47J 31/46

(52) U.S. Cl. CPC A47J 31/5251; A47J 31/002; A47J 31/3671; A47J 31/461; A47J 31/469; A47J 31/5255

(57) ABSTRACT

A coffee percolator (1) includes: a delivery unit (2) configured to deliver water to a filter cup (7) for producing a coffee infusion; a pump unit (3) in fluid connection with said delivery unit (2), and configured to draw water from an external water supply, and to feed said water in a controlled way to said delivery unit (2); a dispensing unit (4) arranged between said delivery unit (2) and said pump unit (3), and configured to take a volumetric amount (Q) of said delivered water; a regulator unit (5) arranged between said delivery unit (2) and said pump unit (3), and configured to control the pressure of the delivered water; an electronic control unit (6) operatively connected to said regulator unit (5), and configured to control, through said regulator unit (5), the delivery pressure (p) of the delivered water; wherein said control unit (6) is operatively connected also to said dispensing unit (4), and configured to define, while delivering said water from said delivery unit (2), two subsequent regulation stages, wherein said delivery pressure (p) is regulated according to one or more predetermined delivery times (t) and one or more volumetric amounts (Q), respectively.

The present invention relates to a coffee percolator and a method of delivering coffee, of the kind specified in the preamble of the first claim.

More particularly, the present invention relates to a coffee percolator comprising a delivery unit preferably provided with a multi-boiler. Coffee percolators of this kind are disclosed in the documents US-A-2016/249763 and US-A-2016/278569.

It is well known that coffee is traditionally a very valuable drink that can be prepared with a multitude of different machines. Among the various kinds, automatic machines and lever actuated machines are more particularly well known.

The automatic coffee percolators comprise at least a delivery unit which may be connected with a filter bowl conveying the coffee infusion to a collection cup, a boiler configured to heat the infusion water, a control push button for actuating the coffee infusion with water, and a pressurization system connected with the delivery unit so as to allow management of the pressure acting on the coffee to be delivered.

Generally, the automatic machines allow to deliver the coffee infusion at a constant pressure, for instance of 9 bar, so that they are not preferred tools to produce high quality coffee.

Indeed, it is already known that, by keeping low the pressure in the coffee pre-infusion first stage, and increasing the pressure in the second infusion stage, which is the stage of real delivery, the produced espresso coffee has organoleptic properties of superior quality, in comparison with coffee produced by application of a constant pressure during the entire coffee delivery cycle.

On the contrary, the lever actuated machines are hand-operated instruments, mostly used by instructed personnel, also comprising at least a delivery unit, which may be connected with a filter bowl conveying the coffee infusion to a collection cup, a boiler configured to heat the infusion water and a pressurization system connected with the delivery unit, so as to allow management of the pressure acting on the coffee to be delivered.

Basically, in operation of the machine, once the filter bowl is charged with a given amount of ground coffee and connected with the delivery unit, one can actuate the lever in order to convey hot water to the ground grain. After the infusion of coffee with hot water, one can return the lever to the start position, at the same time pressing upon the coffee cake, thus causing the drink to be discharged from the filter bowl.

Therefore, the lever actuated machines allow to control professionally both the coffee infusion pressure and the coffee delivery pressure, thus producing a high quality coffee drink. Of course, the main difficulty of using lever machines is to require a correct personnel formation, since the correct infusion of coffee substantially depends on extraction profiles that only the skilled hands of professionals of this field can obtain by using the lever actuated machines.

In such a situation, the technical object of the present invention is to develop a coffee percolator and a related method of delivering coffee allowing to produce a coffee infusion of high quality, in the light of operations automatically controlled by the machine.

Another important object of the invention is to develop a coffee percolator and a related method of delivering coffee, which can be enjoyed by any user, even if not skilled in this art.

The technical problem and the specific objects are attained by a coffee percolator and a related method of delivering coffee, as recited in the annexed claim 1. Preferred technical solutions are pointed out in the dependent claims.

The characteristics and advantages of the invention are hereinafter clarified by the detailed description of preferred embodiments of the invention, with reference to the annexed drawings, wherein:

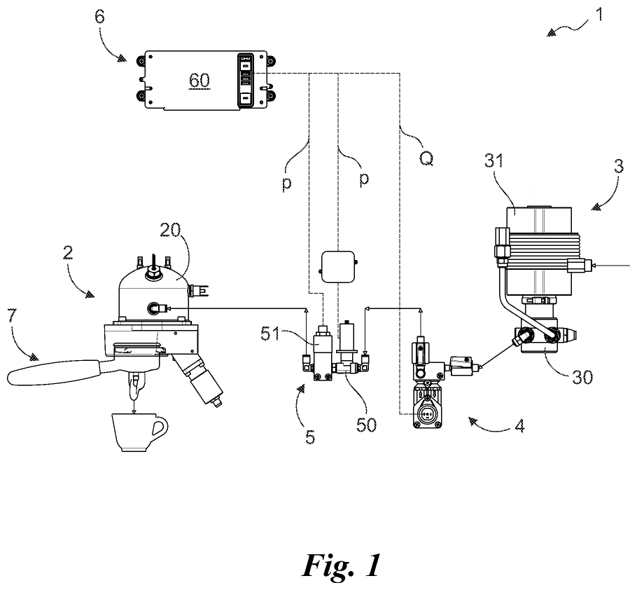

FIG. 1 is a functional diagram of a coffee percolator according to the invention;

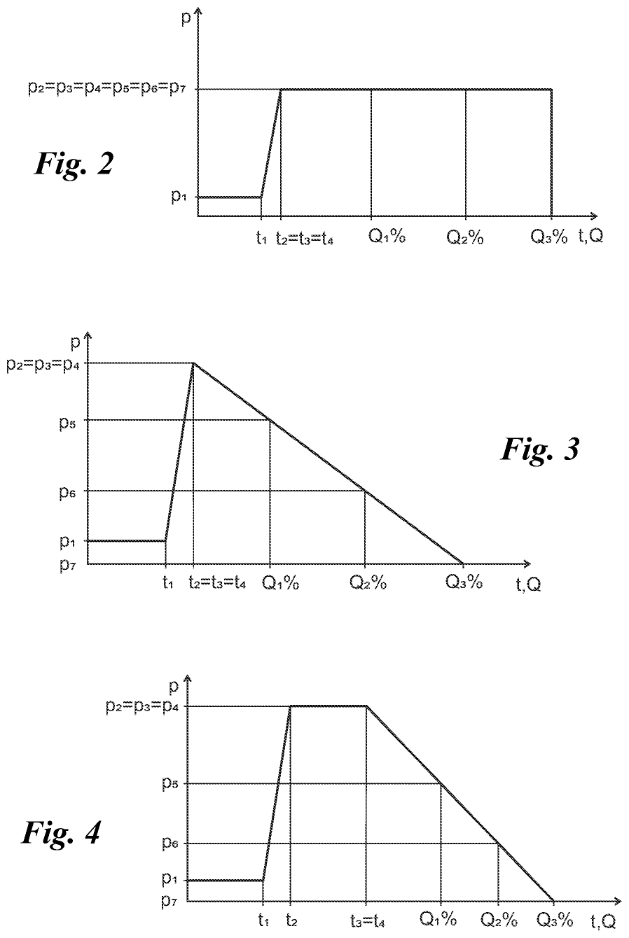

FIG. 2 is an illustrative graph of a method of delivering coffee, implemented according to the invention;

FIG. 3 is a graph illustrating a first embodiment of a method of delivering coffee, implemented according to the invention; and

FIG. 4 is a graph illustrating a second embodiment of a method of delivering coffee, implemented according to the invention.

In this document, measures, values, forms and geometrical references (such as verticalness and parallelism), when associated with such terms as “about” or other similar terms like “almost” or “substantially”, should be understood except for measurement errors or inaccuracies due to production and/or manufacture, and above all for a slight deviation of the value, measure, form or geometrical reference associated therewith. For instance, these terms, when associated with a value, preferably mean a deviation not greater than 10% of the value.

Moreover, when used, terms such as “first”, “second”, “higher”, “lower”, “main” and “secondary” do not necessarily identify an order, a priority of relation or corresponding position, but may be merely used to distinguish different components more clearly from each other.

Unless where specified otherwise, as it will be apparent hereinafter, terms such as “treatment”, “informatics”, “determination”, “calculation” and the like, refer to the action and/or process of a computer or similar device of electronic calculation manipulating and/or transforming data represented as physical ones, such as electronic magnitudes of an informatic system and/or memory, into other data likewise represented as physical quantities inside informatic systems, registers or other devices of storage, transmission or display of data.

The measurements and data reported in the present disclosure are to be considered, unless where otherwise stated, as carried out under the ICAO International Standard Atmosphere (ISO 2533: 1975).

With reference now to the figures of the drawings, the coffee percolator according to the invention is overall shown by reference numeral 1.

The machine 1 is capable of producing a coffee infusion. Therefore, the machine 1 briefly comprises at least a delivery unit 2 and a pump unit 3.

The delivery unit 2 is substantially configured to deliver water. In detail, like in most professional coffee percolators, the delivery unit 2 is configured to deliver water to a filter cup 7. The filter cup 7 substantially comprises a container for ground coffee, bored at its bottom so as to allow passage of coffee infusion, produced by wetting the coffee therein contained with pressurized hot water. The filter cup 7 generally comprises a handgrip suitable for an easy hold by the user. At any rate, the filter cup 7 is known per se to a man skilled in the art and may be part of the machine 1 or simply compatible thereto.

Therefore, the delivery unit 2 is configured to supply water to the filter cup 7 for producing the coffee infusion. In detail, the delivery unit 2 may comprise a connection portion, with which the filter cup 7 may be connected. Moreover, the delivery unit 2 may comprise a boiler 20, which may be a kind of multi-boiler.

The pump unit 3 instead is configured to draw water from an external water supply or a suitable container. Moreover, it may be configured to convey water in a controlled way to the delivery unit 2. Therefore, the pump unit 3 is in connection of fluid passage with the delivery unit 2. In order to make this connection, the machine 1 may obviously comprise a suitable hydraulic circuit. The pump unit 3 may include a pump 30, which is substantially of a type common in the field of coffee percolators. In any case, it is sufficient that the pump 30 is so configured as to convey, namely to pump water. The pump 30 may be actuated by a motor 31.

When present, motor 31 is part of the pump unit 3. Therefore, motor 31 is configured to actuate pump 30 under control. For instance, motor 31 may be asynchronous. Moreover, motor 31 may be provided with a water cooling system. When present, water cooling is effected by the same water coming from the hydraulic network external to pump 30. Therefore water, flowing through the motor body 31, not only cools and makes it more efficient, but is also partially heated before entering pump 30. After exit from pump 30, water is being pressurized and conveyed to the delivery unit 2.

The machine 1 may advantageously include further components. Preferably, machine 1 comprises intermediate components, operatively arranged between the delivery unit 2 and the pump unit 3. Therefore, machine 1 comprises a distribution unit 4. The distribution unit 4 is arranged between the delivery unit 2 and the pump unit 3.

The distribution unit 4 is advantageously configured to acquire the volumetric quantity Q of delivered water. Therefore, the volumetric quantity Q is being measured when water outgoing from the pump unit 3, more particularly from pump 30, is conveyed to the delivery unit 2. In any case, any sensor suitable to detect said volumetric quantity Q may be advantageously used in machine 1.

The machine 1 comprises also a regulation unit 5. The regulation unit 5 is arranged like the distribution unit 4, between the delivery unit 2 and the pump unit 3. For instance, as a further detail, the regulation unit 5 may be arranged downstream the distribution unit 4.

Advantageously, the regulation unit 5 is configured to control the pressure of the delivered water. Therefore, the regulation unit 5 may be able to acquire at least the value p of delivery pressure, to which the delivered water is subjected, or when entering the delivery unit 2.

The delivery pressure p may coincide with the pressure given to water by pump 30. Otherwise, the delivery pressure p may be suitably controlled by the regulation unit 5. To this end, the regulation unit 5 may comprise a valve 50. Valve 50 in detail may be configured to control the delivery pressure p. Preferably, valve 50 is a motor-operated step-by-step proportional valve. An example of this kind of valve 50 is disclosed in the document EP 2991530 B, paragraphs [0036] to [0040] and FIGS. 1-3, herein incorporated as reference.

The regulation unit 5 also comprises a pressure transducer 51. The pressure transducer 51 is only optional for operation of valve 50 and is configured to acquire the delivery pressure p just at the output from valve 50. More particularly, the pressure transducer 51 allows to make a feedback control of valve 50.

Indeed, machine 1 may preferably comprise also a control unit 6. This control unit 6 is preferably electronic and is operatively connected with the regulation unit 5. Therefore, the control unit 6 is configured to control through the regulation unit 5 the delivery pressure p of the delivered water.

More particularly, the control unit 6 is operatively connected with both valve 50 and the pressure transducer 51. The control unit 6 may control the valve 50 and at the same time through the pressure transducer 51 check if the actual delivery pressure p corresponds to the control pressure. Thus, the control unit 6 makes a feedback control of valve 50.

The control unit 6 may therefore include a simple electronic card 60. This electronic card 60 is a component known per se, provided at least with a processor and possibly an internal storage, that can efficiently execute commands given from outside or even by an algorithm recorded in an internal storage. In general, the control unit 6 allows to perform a control system of machine 1.

Advantageously, the control unit 6 is also operatively connected with the distribution unit 4. Moreover, the control unit 6 is configured to define two regulation stages during delivery of water to the delivery unit 2. The regulation stages are made by the control unit 6 and are mutually either successive or consecutive. In detail, in the first regulation stage, the delivery pressure p is adjusted in relation to one or more predetermined delivery times t. The delivery times t may be determined by the control unit 6 and define substantially the time duration of water outflow from the delivery unit 2.

In the second regulation stage, the delivery pressure p is adjusted in relation to one or more volumetric quantities Q. The regulation according to volumetric quantities Q may be based on absolute or relative data. This means that the machine may be configured to adjust pressure according to either absolute volumetric quantities Q of delivered water, or to relative volumetric possibly percent quantities of delivered water in comparison with a predetermined quantity of water to be delivered.

For instance, if the control unit 6 is so configured as to cause delivery of a given quantity of water per coffee infusion, the pressure regulation in the second regulation stage, may occur by reaching percent volumetric quantities Q based on a predetermined quantity. Examples of this kind of control will be better explained hereinafter.

Therefore, machine 1 allows to carry out substantially a hybrid control of water delivery from the delivery unit 2 to the filter cup 7, in order to obtain a coffee infusion.

The operation of the coffee percolator 1 above described in structural terms, is similar to the operation of any conventional coffee percolator. However, the present invention comprises a novel process of coffee delivery. More particularly, the process includes a delivery stage. In the delivery stage, water is delivered by the delivery unit 2 to obtain a coffee infusion. Advantageously, the delivery stage comprises two substages. Indeed, during the delivery stage, at first the delivery pressure p is regulated in respect of one or more predetermined delivery times t.

After the first regulation, the delivery pressure p is regulated in respect of one or more predetermined volumetric quantities Q, as described hereinbefore. Thus, delivery of the infusion is effected by controlling pressure according to specific logics.

Therefore, the invention allows to make a control system for coffee percolators, comprising means for implementing a process as hereinbefore described.

Moreover, the invention allows to carry out a computer program comprising instructions allowing the computer to execute an above described process, when the program is executed by said computer.

In conclusion, the invention allows to make a file system that can be read by computer, comprising instructions that, when executed by said computer, allow said computer to execute an above described process.

As already stated, the system may be substantially implemented by the control unit 6. Therefore, the program and the file may be part of the control unit 6, for instance implemented more particularly in a control card 60.

Thus, the invention allows to program the machine 1 to make delivery systems comparable to the operation of the manually operated lever machines. Thus, programming allows to control suitably the pressure variation law as a function of the delivered dose.

Examples of operation profiles are hereinafter illustrated.

In a preferred but not exclusive embodiment, the control system for instance may be based on filling in a table comprising two lines and seven columns, allowing to define a total of 14 values. The control matrix therefore may be made as follows, where the values to be stated of delivery pressure p, delivery time t and volumetric quantity Q, given as a percent value of a given predetermined quantity, are differentiated by subscripts.

| | | | | | | | |
|---|---|---|---|---|---|---|---|
| Pressure [bar] | p1 | p2 | p3 | p4 | p5 | p6 | p7 |
| Time [seconds] | t1 | t2 | t3 | t4 | | | |
| Volumetric quantity % | | | | | Q1% | Q2% | Q3% |

The control characteristic is that the defined pressure value is a function of time for the first four values of the table and a percent value of the delivered volumetric quantity Q for the following three values. The pressure value is measured by the pressure transducer 51. The delivery time t in seconds is given by the count started together with delivery. The percent value of the volumetric quantity Q of the delivered water is obtained through the data coming from the volumetric counter of the distribution unit 4.

In a first example of delivery of a volumetric quantity of 30 cc/cm³, shown in FIG. 2, the following values are stated:

| | | | | | | | |
|---|---|---|---|---|---|---|---|
| Pressure [bar] | 1 | 9 | 9 | 9 | 9 | 9 | 9 |
| Time [seconds] | 5 | 7 | 7 | 7 | | | |
| Volumetric quantity % | | | | | 50% | 75% | 100% |

Basically, the table shows a traditional operational profile, with constant pressure of 9 bar which is typical of the traditional electronic machines.

In a second example of delivery of a volumetric quantity of 30 cc/cm³, shown in FIG. 3, the following values are stated:

| | | | | | | | |
|---|---|---|---|---|---|---|---|
| Pressure [bar] | 1 | 12 | 12 | 12 | 8 | 4 | 0 |
| Time [seconds] | 5 | 7 | 7 | 7 | | | |
| Volumetric quantity % | | | | | 50% | 75% | 100% |

Basically, the table shows a traditional lever operated profile. This pressure profile provides for a coffee pre-infusion stage, occurring at a pressure value to be programmable and in any case very low to allow the correct wetting for a time to be stated.

At the end of the pre-infusion stage, the real coffee delivery starts, with a sudden increase of pressure up to the previously programmed top value.

Once the top value is reached, pressure starts to gradually decrease in a fully similar way as it happens in a lever machine, and the delivery ends with a small residual pressure.

In a third example of delivery of a volumetric quantity of 30 cc/cm³, shown in FIG. 4, the following values are stated:

| | | | | | | | |
|---|---|---|---|---|---|---|---|
| Pressure [bar] | 1 | 12 | 12 | 12 | 8 | 4 | 0 |
| Time [seconds] | 5 | 7 | 15 | 15 | | | |
| Volumetric quantity % | | | | | 50% | 75% | 100% |

Basically, the table shows an extended lever profile. For this pressure profile, one may state the preinfusion time and the maximum pressure, and also set how long to keep this maximum pressure, before starting the stage of gradual reduction of the pressure up to the delivery end.

In conclusion, in a fourth example of delivery of a volumetric quantity of 30 cc/cm³, not shown in the drawings, the following values are stated:

| | | | | | | | |
|---|---|---|---|---|---|---|---|
| Pressure [bar] | 1 | 11 | 6 | 11 | 7 | 4 | 2 |
| Time [seconds] | 5 | 7 | 15 | 23 | | | |
| Volumetric quantity % | | | | | 70% | 85% | 100% |

Basically, the table shows a personalized profile. This pressure profile, for instance, may be fully varied. This pressure profile allows the maximum freedom of stating pressure values and creating unusual profiles, so as to obtain the most suitable extraction from any blend and the best quality of coffee cup infusion.

A practical example might be a profile resembling the letter M, i.e. a curve like the pressure profile obtained with the lever machines by the restart move approximately at half delivery time.

Generally speaking, as can be seen from the above illustrated examples, at the delivery start, it is preferable to reason in terms of delivery time t, to define the coffee preinfusion time, corresponding to a coffee wetting at an almost room pressure, and the subsequent stages of increasing and preserving the delivery pressure p.

On the contrary, at the end of delivery, predominant is the delivered volume, since the actual delivery time t might be variable for each delivery, in view of other uncontrollable parameters such as the grinding quality of the coffee grains.

Therefore, it is globally preferable to define the value of the delivery pressure p on the basis of the actual volumetric quantity Q of delivered coffee, in comparison with the quantity that will be as a whole delivered, corresponding to the quantity predetermined before the delivery.

The coffee percolator or machine 1, and the related delivery method, according to the present invention, attains important advantages.

Indeed, the coffee percolator and the related delivery method, allow to make a coffee infusion of high quality, in the light of operations automatically performed by the same machine, or if desired that may be fully managed by an operator. Moreover, the coffee percolator and the related delivery method may be easily managed by any user, even unskilled in this art.

The invention is susceptible of variations falling within the object of the inventive concept defined in the appended claims.

For instance, the control unit 6 may obviously comprise an access panel, e.g. operatively connected with the electronic card 60. Suitable for the user to have access to programming of the coffee percolator 1, so as to allow the manipulation at will of the parameters, namely the values of delivery pressure p, delivery time t and volumetric quantity Q.

Obviously, the panel may comprise a button strip as well as display devices, suitable for showing to the user the effected changes of parameters as well as the operational profiles, if required, as shown for instance in FIGS. 2-4.

The control unit 6 may also be configured to suggest to the user several operational profiles preset and possibly saved in the main memory of the control unit 6.

In this connection, all the details may be replaced by equivalent elements, and their materials, forms and dimensions may be freely chosen.

1. A coffee percolator comprising:
a delivery unit configured to deliver water to a filter cup for producing a coffee infusion;
a pump unit in fluid connection with said delivery unit, and configured to draw water from an external water supply, and to feed said water in a controlled way to said delivery unit;
a dispensing unit arranged between said delivery unit and said pump unit, and configured to take a volumetric amount of said delivered water;
a regulator unit arranged between said delivery unit and said pump unit, and configured to control the pressure of the delivered water;
an electronic control unit operatively connected to said regulator unit, and configured to control, through said regulator unit, the delivery pressure of the delivered water;
wherein said control unit is operatively connected also to said dispensing unit, and configured to define, while delivering said water from said delivery unit, two subsequent regulation stages, wherein said delivery pressure is regulated according to one or more predetermined delivery times and one or more volumetric amounts, respectively.

2. The coffee percolator according to claim 1, wherein said regulator unit comprises a valve configured to control said water delivery pressure and at least a pressure transducer configured to acquire said delivery pressure in such a way that said control unit has a feedback on said valve.

3. The coffee percolator according to claim 2, wherein said valve is a stepping motor operated proportional valve.

4. The coffee percolator according to claim 1, wherein said pump unit comprises a pump configured to convey said water and a motor configured to operatively actuate said pump.

5. The coffee percolator according to claim 4, wherein said motor is an asynchronous motor, provided with a water cooling system.

6. The coffee percolator according to claim 1, wherein said delivery unit comprises a multi-boiler.

7. A method of delivering coffee implemented by a coffee percolator according to claim 1, comprising at least the step of delivering said water from said delivery unit to produce a coffee infusion,
and wherein, during said delivery stage, said method comprises the following sequential steps:
regulating said delivery pressure according to one or more predetermined delivery times, and
regulating said delivery pressure according to one or more volumetric amounts.

8. A control system for a coffee percolator, comprising means for implementing a process according to claim 7.

9. A computerized program comprising instructions that, when the program is executed by a computer, allow the computer to execute a method according to claim 7.

10. A computer readable filing medium, comprising instructions that, when the program is executed by said computer, allow the computer to execute a method according to claim 7.
